(19) United States
(12) Patent Application Publication
(10) Pub. No.: US 2017/0266976 A1
(43) Pub. Date: Sep. 21, 2017

(54) MAINTENANCE METHOD OF LIQUID EJECTION PRINTING DEVICE

(71) Applicant: SII Printek Inc., Chiba-shi (JP)

(72) Inventor: Daiki IROKAWA, Chiba-shi (JP)

(21) Appl. No.: 15/460,766

(22) Filed: Mar. 16, 2017

(30) Foreign Application Priority Data
Mar. 18, 2016 (JP) 2016-055879

(51) Int. Cl. B41J 2/165

(52) U.S. Cl. CPC B41J 2/16523

(57) ABSTRACT

A maintenance method of a liquid ejection printing device includes: forming a lump of trapped liquid in a nozzle plate to cover a nozzle hole and a surrounding of the nozzle hole with ink while a printing operation on a printing medium is performed and the liquid is not ejected; and suctioning the lump of trapped liquid into an ejection channel after the forming of the lump of trapped liquid.

### RELATED APPLICATIONS

This application claims priority under 35 U.S.C. §119 to Japanese Patent Application No. 2016-055879 filed on Mar. 18, 2016, the entire content of which is hereby incorporated by reference.

### BACKGROUND

Technical Field

The present invention relates to a maintenance method of a liquid ejection printing device.

Related Art

In the related art, a liquid ejection printing device of an ink jet system (an ink jet printer) that performs a variety of printing operations on a printing medium such as a sheet of paper is known. Such a type of liquid ejection printing device includes a liquid tank in which ink is stored, and a liquid ejection head (an ink jet head) that is supplied with liquid via a liquid supply tube (an ink supply tube) from a liquid tank. The liquid ejection head includes an actuator plate in which plural channels filled with ink and a nozzle plate in which plural nozzle holes communicating with the channels are formed.

The actuator plate is formed of a piezoelectric material such as a lead zirconate titanate (PZT). In this configuration, when a voltage is applied to the actuator plate, the volumes of the channels vary due to a piezoelectric slip effect. Ink is ejected from the nozzle holes using a pressure which is generated by the variation. The ink ejected from the nozzle holes is impacted on a printing medium and thus characters or images are printed on the printing medium.

Liquid ejection heads are classified into, for example, an edge shoot type liquid ejection head (hereinafter simply referred to as an “edge shoot type head”) and a side shoot type liquid ejection head (hereinafter simply referred to as a “side shoot type head”).

In the edge shoot type head, a nozzle hole is located at a downstream end of a liquid channel. On the other hand, the side shoot type head includes a liquid discharge tube that discharges ink from a channel in addition to the liquid supply tube, and ink circulates in the side shoot type head. The nozzle hole is located in the middle of the liquid channel.

When bubbles are present in the channel, ink is not appropriately supplied due to a pressure loss and thus ejection of ink from the nozzle gets unstable. Accordingly, various techniques for maintenance of removing the bubbles in the channel are disclosed.

For example, a technique of providing a supply pump that supplies ink to a liquid ejection head (a line head) and a suction pump that suctions ink from the liquid ejection head and replacing ink in an ink channel or filling the ink channel with ink by driving the supply pump and the suction pump is disclosed (for example, see JP 2008-132762 A).

According to the technique, the liquid ejection head is once returned to a service station in performing maintenance. Thereafter, ink in the channel is pushed out of a nozzle hole by driving the supply pump and the ink pushed out of the nozzle hole is suctioned and returned to the liquid ejection head by driving the suction pump.

When a head tip is initially filled with ink or ink is ejected from the head tip, the ink may fly out and be attached to the nozzle plate. In this case, ejected ink may be deflected by the ink attached to the nozzle plate or the ejection of ink may be hindered. Accordingly, various techniques for maintenance of removing ink attached to the nozzle plate are disclosed.

For example, a technique of forming a recovery hole in a nozzle plate, causing recovered liquid to overflow from the recovery hole onto the surface of the nozzle plate, and recovering the overflowing recovered liquid along with ink attached to the nozzle plate from the recovery hole (for example, see JP 2010-234652 A).

### SUMMARY OF THE INVENTION

However, in the technique disclosed in JP 2008-132762 A, there is a possibility that driving control of the pumps or control of the ink ejection timing of the liquid ejection head will be complicated and ink ejection failure will be easily caused. In performing maintenance, since the liquid ejection head has to be once returned to the service station, there is a problem in that time is required for the maintenance.

In the technique disclosed in JP 2010-234652, since the recovery hole in addition to the nozzle hole needs to be formed in the nozzle plate, there is a problem in that a processing cost increases.

Therefore, the present invention is made in consideration of the above-mentioned circumstances and provides a maintenance method of a liquid ejection printing device that can satisfactorily prevent ink ejection failure, shorten a maintenance time, and perform maintenance using an inexpensive method.

To achieve the above object, in a maintenance method of a liquid ejection printing device according to the present invention, the liquid ejection printing device includes a liquid tank that stores liquid, a liquid ejection head that ejects the liquid to a printing medium, and a liquid circulating unit that circulates the liquid between the liquid tank and the liquid ejection head, the liquid ejection head including a nozzle plate in which a nozzle hole through which the liquid is ejected is formed, and a plurality of channels that communicates with the nozzle hole and is filled with the liquid, the liquid circulating unit including a liquid supply tube that supplies the liquid from the liquid tank to the liquid ejection head, and a liquid discharge tube that discharges the liquid from the liquid ejection head, and the maintenance method comprising steps of forming a lump of trapped liquid on the nozzle plate so as to cover the nozzle hole and a surrounding of the nozzle hole with the liquid while a printing operation onto the printing medium is performed and the liquid is not ejected, and suctioning the lump of trapped liquid into the corresponding channel after the step of forming the lump of trapped liquid.

In this way, by forming a lump of trapped liquid in the nozzle plate, ink attached to the nozzle plate can be adsorbed by the lump of trapped liquid. Then, by suctioning the lump of trapped liquid, the ink attached to the nozzle plate can be recovered into the channel along with the lump of trapped ink. Since maintenance can be performed with this simple operation, it is possible to prevent complication of maintenance control and to satisfactorily prevent ink ejection failure. Since it is not necessary to form a recovery hole other than the nozzle hole unlike in the related art, it is possible to perform maintenance using an inexpensive method.

It is not necessary to once return the liquid ejection head to a service station in performing maintenance, and the maintenance can be performed when a printing operation on a printing medium is performed and liquid is not ejected. Accordingly, it is possible to shorten a maintenance time.

For example, in a shuttle machine that performs round-trip printing, deflection of ink ejection or ink ejection failure due to attachment of ink to the nozzle plate can be recovered for every round-trip movement in an acceleration/deceleration area in which ejection of ink is not performed.

In the maintenance method of a liquid ejection printing device according to the present invention, in the step of forming the lump of trapped liquid, the lump of trapped liquid is formed by pressurizing the liquid in the channel so as to break a meniscus formed in the nozzle hole.

By employing this method, a lump of trapped liquid can be simply formed in a nozzle plate. Accordingly, it is possible to further facilitate maintenance control.

In the maintenance method of a liquid ejection printing device according to the present invention, in the step of forming the lump of trapped liquid, the liquid in the channel is pressurized by pressurizing the liquid in the liquid supply tube.

By employing this method, it is possible to satisfactorily pressurize liquid in the channel and to satisfactorily form a lump of trapped liquid.

In the maintenance method of a liquid ejection printing device according to the present invention, a pressurization pump is disposed in the liquid supply tube and the liquid in the liquid supply tube is pressurized by the pressurization pump.

By employing this method, it is possible to satisfactorily pressurize liquid in the liquid supply tube with a simple structure.

In the maintenance method of a liquid ejection printing device according to the present invention, the liquid tank includes a supply sub tank that is connected to the liquid supply tube, and a discharge sub tank that is connected to the liquid discharge tube, and a position of the supply sub tank is set to be higher than a position of the discharge sub tank so that the liquid in the liquid supply tube is pressurized by a head difference between a liquid level of the liquid in the supply sub tank and a liquid level of the liquid in the channel.

By employing this method, it is possible to satisfactorily pressurize liquid in the liquid supply tube with a simpler structure.

In the maintenance method of a liquid ejection printing device according to the present invention, an intercept portion that is capable of intercepting a channel of the liquid in the liquid discharge tube is disposed in the liquid discharge tube, and the liquid in the liquid supply tube is pressurized by the head difference caused by intercepting the channel of the liquid discharge tube using the intercept portion.

By employing this method, it is possible to simply pressurize liquid in the liquid supply tube with a simple structure.

According to the present invention, by forming a lump of trapped liquid in the nozzle plate, ink attached to the nozzle plate can be adsorbed by the lump of trapped liquid. Then, by suctioning the lump of trapped liquid, the ink attached to the nozzle plate can be recovered into the channel along with the lump of trapped ink. Since maintenance can be performed with this simple operation, it is possible to prevent complication of maintenance control and to satisfactorily prevent ink ejection failure. Since it is not necessary to form a recovery hole other than the nozzle hole unlike in the related art, it is possible to perform maintenance using an inexpensive method.

It is not necessary to once return the liquid ejection head to a service station in performing maintenance, and the maintenance can be performed when a printing operation on a printing medium is performed and liquid is not ejected. Accordingly, it is possible to shorten a maintenance time.

### BRIEF DESCRIPTION OF THE DRAWINGS

FIG. 1 is a perspective view illustrating a liquid ejection printing device according to an embodiment of the present invention;

FIG. 2 is a diagram schematically illustrating configurations of a liquid ejection head, sub tanks, and a liquid circulating unit according to a first embodiment of the present invention;

FIG. 3 is a diagram schematically illustrating a configuration of a head tip according to the embodiment of the present invention;

FIGS. 4A to 4C are diagrams illustrating ink which is ejected from a nozzle hole according to the embodiment of the present invention, where behavior of ink is illustrated;

FIGS. 5A to 5C are diagrams illustrating a maintenance method according to the embodiment of the present invention, where behavior of ink is illustrated;

FIG. 6 is a diagram schematically illustrating configurations of a liquid ejection head, sub tanks, and a liquid circulating unit according to a modified example of the first embodiment of the present invention;

FIG. 7 is a diagram schematically illustrating configurations of a liquid ejection head, sub tanks, and a liquid circulating unit according to a second embodiment of the present invention; and

FIG. 8 is a diagram schematically illustrating configurations of a liquid ejection head, sub tanks, and a liquid circulating unit according to a third embodiment of the present invention.

### DETAILED DESCRIPTION OF THE INVENTION

Hereinafter, embodiments of the present invention will be described with reference to the accompanying drawings.

(Liquid Ejection Printing Device)

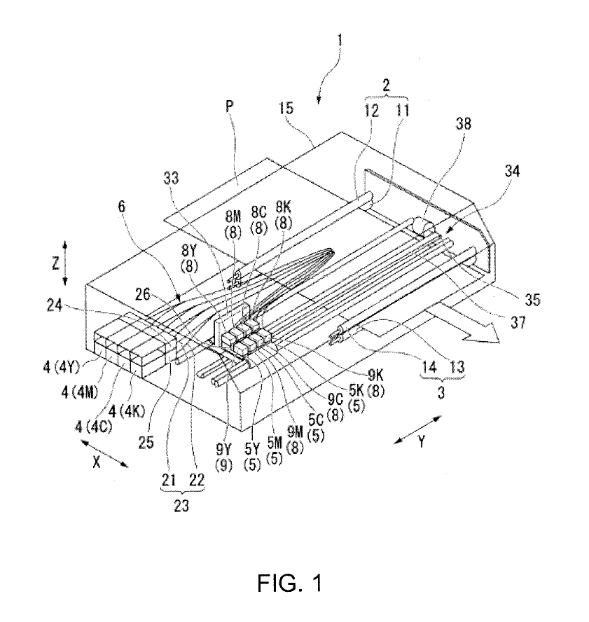

FIG. 1 is a perspective view illustrating a liquid ejection printing device 1.

The liquid ejection printing device 1 is a so-called ink jet printer and includes, in a housing 15, a pair of conveyance mechanisms 2 and 3 that conveys a printing medium P such as a sheet of paper, a main tank 4 and sub tanks 8 and 9 (a supply sub tank 8 and a discharge sub tank 9) in which ink is stored, a liquid ejection head 5 that ejects ink droplets to the printing medium P, a liquid circulating unit 6 that circulates ink between the main tank 4 and the liquid ejection head 5 via the sub tanks 8 and 9, and a scanning unit 7 that causes the liquid ejection head 5 to scan in a direction (a sub scanning direction) which is perpendicular to a conveyance direction (a main scanning direction) of the printing medium P.

In the drawings which are used in the following description, scales of elements are appropriately changed for the purpose of making the elements in recognizable sizes.

In the following description, the main scanning direction is defined as an X direction, the sub scanning direction is defined as a Y direction, and a direction perpendicular to both the X direction and the Y direction is defined as a Z direction. The liquid ejection printing device 1 is placed for use such that the X direction and the Y direction are parallel to the horizontal direction and the Z direction is parallel to an upward direction and a downward direction in the gravitational direction.

That is, in a state in which the liquid ejection printing device 1 is placed, the liquid ejection head 5 scans over a printing medium P in the horizontal direction (the X direction and the Y direction). Ink droplets are ejected downward in the gravitational direction (downward in the Z direction) from the liquid ejection head 5 and the ink droplets are impacted on the printing medium P.

The conveyance mechanism 2 includes a grit roller 11 that is disposed to extend in the Y direction, a pinch roller 12 that is disposed to extend in parallel to the grit roller 11, and a driving mechanism (not illustrated) such as a motor that axially rotates the grit roller 11.

Similarly, the conveyance mechanism 3 includes a grit roller 13 that is disposed to extend in the Y direction, a pinch roller 14 that is disposed to extend in parallel to the grit roller 13, and a driving mechanism (not illustrated) such as a motor that axially rotates the grit roller 13.

The main tank 4 and the sub tanks 8 and 9 are independently disposed. The sub tanks 8 and 9 are disposed in the vicinity of the liquid ejection head 5, and the main tank 4 is disposed in the housing 15 separately from the sub tanks 8 and 9. Details of the sub tanks 8 and 9 will be described later.

In the main tank 4, for example, main tanks 4Y, 4M, 4C, and 4K of four types of ink of yellow, magenta, cyan, and black are arranged in the X direction. The main tank 4 is not limited to the main tanks 4Y, 4M, 4C, and 4K in which four types of ink of yellow, magenta, cyan, and black are stored, but may additionally include ink tanks in which multiple colors of ink are stored.

The scanning unit 7 includes a pair of guide rails 31 and 32 that is disposed to extend in the Y direction, a carriage 33 that is supported to be movable along the pair of guide rails 31 and 32, and a driving mechanism 34 that causes the carriage 33 to move in the Y direction. The driving mechanism 34 includes a pair of pulleys 35 and 36 that is disposed between the guide rails 31 and 32, an endless belt 37 that is suspended between the pulleys 35 and 36, and a driving motor 38 that rotationally drives one pulley 35.

The pulleys 35 and 36 are disposed between both ends of the pair of guide rails 31 and 32. The endless belt 37 is disposed between the guide rails 31 and 32. The carriage 33 is connected to the endless belt 37.

In the carriage 33, as plural liquid ejection heads 5, liquid ejection heads 5Y, 5M, 5C, and 5K individually corresponding to four colors of ink of yellow, magenta, cyan, and black are mounted in parallel in the Y direction. Accordingly, the liquid ejection head 5 moves relative to a printing medium P. The liquid ejection heads 5Y, 5M, 5C, and 5K have the same configuration except for the colors of ink supplied thereto, and thus are referred to as liquid ejection heads 5 together in the following description.

### First Embodiment

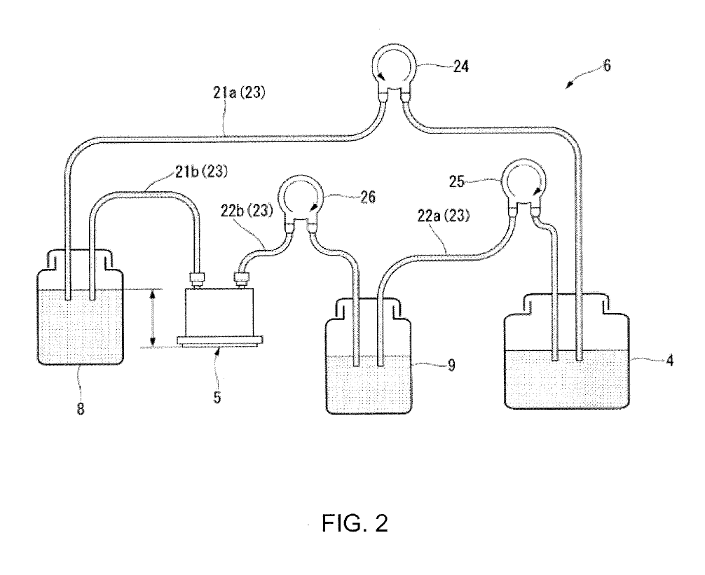

FIG. 2 is a diagram schematically illustrating the configurations of the liquid ejection head 5, the sub tanks 8 and 9, and the liquid circulating unit 6.

As illustrated in FIGS. 1 and 2, the sub tanks 8 and 9 in addition to the liquid ejection head 5 are mounted on the carriage 33. The sub tanks 8 and 9 include a supply sub tank 8 that supplies ink to the liquid ejection head 5 and a discharge sub tank 9 that stores ink discharged from the liquid ejection head 5. The sub tanks 8 and 9 include supply sub tanks 8Y, 8M, 8C, and 8K and discharge sub tanks 9Y, 9M, 9C, and 9K in which four colors of ink of yellow, magenta, cyan, and black are stored to correspond to the liquid ejection heads 5Y, 5M, 5C, and 5K.

(Liquid Circulating Unit)

The liquid circulating unit 6 includes a circulation channel 23. The circulation channel 23 includes two liquid supply tubes 21a and 21b that supply ink from the main tank 4 to the liquid ejection head 5 via the supply sub tank 8 and two liquid discharge tubes 22a and 22b that return ink from the liquid ejection head 5 to the main tank 4 via the discharge sub tank 9.

The liquid circulating unit 6 includes a supply pump 24 that sends out ink stored in the main tank 4 to the supply sub tanks 8Y, 8M, 8C, and 8K, a suction pump 26 that suctions and sends out ink supplied to the liquid ejection head 5 to the discharge sub tanks 9Y, 9M, 9C, and 9K, and a recovery pump 25 that recovers ink from the discharge sub tanks 9Y, 9M, 9C, and 9K to the main tank 4. For example, a so-called tube pump is used as the pumps 24, 25, and 26.

The first liquid supply tube 21a of the two liquid supply tubes 21a and 21b is connected to the supply pump 24 and the supply sub tank 8. The second liquid supply tube 21b of the two liquid supply tubes 21a and 21b is connected to the supply sub tank 8 and the liquid ejection head 5.

On the other hand, the first liquid discharge tube 22a of the two liquid discharge tubes 22a and 22b is connected to the recovery pump 25 and the discharge sub tank 9. The second liquid discharge tube 22b of the two liquid discharge tubes 22a and 22b is connected to the discharge sub tank 9 and the liquid ejection head 5.

The liquid supply tubes 21a and 21b and the liquid discharge tubes 22a and 22b are formed of flexible hoses capable of coping with movement of the scanning unit 7 supporting the liquid ejection head 5.

Four suction pumps 26 are disposed on the carriage 33 to correspond to the liquid ejection heads 5Y, 5M, 5C, and 5K. Each suction pump 26 is disposed in the middle of the second liquid discharge tube 22b. The supply pump 24, the recovery pump 25, and the suction pump 26 have a sealed structure so as not to open the circulation channel 23 (the liquid supply tubes 21a and 21b and the liquid discharge tubes 22a and 22b) to the air when they are stopped.

Here, the supply sub tank 8 and the discharge sub tank 9 are disposed to have different liquid levels. That is, the supply sub tank 8 is disposed such that the liquid level of the supply sub tank 8 is higher than the liquid level of the discharge sub tank 9. Accordingly, the pressure of ink in the second liquid supply tube 21b is normally greater than the pressure of ink in the second liquid discharge tube 22b.

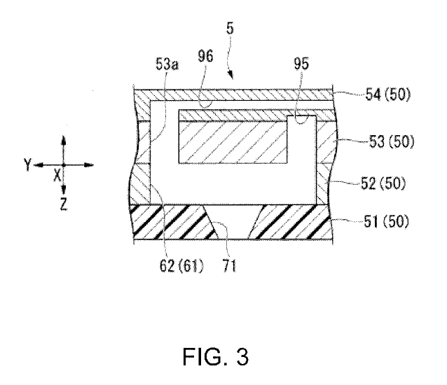

FIG. 3 is a diagram schematically illustrating the configuration of a head tip 50 constituting the liquid ejection head 5.

As illustrated in the drawing, the liquid ejection head 5 includes a head tip 50 including a nozzle plate 51, an actuator plate 52, a cover plate 53, and a channel plate 54. The nozzle plate 51, the actuator plate 52, the cover plate 53, and the channel plate 54 are sequentially stacked in the Z direction using an adhesive or the like. The head tip 50 is disposed such that the nozzle plate 51 faces the downside in the Z direction (to a printing medium P side).

The actuator plate 52 is a plate which is formed in a rectangular plate shape long in the X direction out of a piezoelectric material such as a lead zirconate titanate (PZT). For example, a so-called monopole substrate of which a polarization direction is set to a direction parallel to the thickness direction (the Z direction) is used as the actuator plate 52. Plural channels 61 having a groove shape long in the Y direction are formed in the actuator plate 52.

As the channels 61, an ejection channel 62 which is filed with ink and a non-ejection channel which is not filled with ink are alternately arranged in the X direction. In FIG. 3, only the ejection channel 62 is illustrated and the non-ejection channel is not illustrated. The channels 61 which are arranged in the X direction are referred to as one channel column. The channels 61 are knitted by arranging the channel columns in the Y direction.

The ejection channel 62 is formed to extend in the Y direction. Driving electrodes which are not illustrated are formed on the side surfaces of the channels 61. When a driving voltage is applied to the driving electrodes from a control unit which is not illustrated, the volume in the ejection channel 62 varies.

The cover plate 53 is formed to close the non-ejection channel and includes an opening 53a that causes the ejection channels 62 in the same channel column to communicate with each other. The opening 53a is formed to communicate with both ends in the length direction of the ejection channel 62.

The channel plate 54 includes a supply channel 95 that cause the second liquid supply tube 21 to communicate with one end of the ejection channel 62 (the right end in FIG. 2) and a discharge channel 96 that causes the second liquid discharge tube 22b to communicate with the other end of the ejection channel 62 (the left end in FIG. 2).

The nozzle plate 51 is a plate which is formed in a rectangular plate shape long in the X direction to correspond to the shape of the actuator plate 52 out of a film material of polyimide or the like with a thickness of about 50 μm. The nozzle plate 51 includes plural nozzle holes 71 that communicate with the ejection channels 62, respectively. Each nozzle hole 71 is formed substantially at the center in the extending direction (the Y direction) of the corresponding ejection channel 62.

In this way, the liquid ejection head 5 is of a so-called side shoot type which ejects ink from the substantially center in the channel extending direction (the Y direction) in the ejection channel 62.

(Operation of Liquid Ejection Printing Device)

A case in which characters or figures are printed on a printing medium P using the liquid ejection printing device 1 will be described below.

In an initial state, it is assumed that four main tanks 4, four supply sub tanks 8, and four discharge sub tanks 9 illustrated in FIG. 1 are sufficiently filled with different colors of ink. It is also assumed that the liquid ejection head 5 is filled with ink in the main tank 4 via the liquid circulating unit 6. In the initial state, it is assumed that the carriage 33 waits in a service station which is not illustrated and which is disposed at one of both ends of the guide rails 31 and 32.

In the initial state, when the liquid ejection printing device 1 operates, the grit rollers 11 and 13 of the conveyance mechanisms 2 and 3 rotate and a printing medium P between the grit rollers 11 and 13 and the pinch rollers 12 and 14 is conveyed in the conveyance direction (the X direction). At the same time, the driving motor 38 rotates the pulleys 35 and 36 to move the endless belt 37. Accordingly, the carriage 33 moves from the service station which is not illustrated and is additionally guided by the guide rails 31 and 32, whereby the carriage 33 moves in the Y direction in a round-trip manner. Characters or figures can be printed by appropriately ejecting four colors of ink to the printing medium P from the liquid ejection heads 5. In this way, the liquid ejection printing device 1 is a so-called shuttle machine that causes the carriage 33 (the liquid ejection head 5) to move in a round-trip manner to print characters or figures.

When the printing is being performed, the carriage 33 repeatedly moves in a round-trip manner in the Y direction without being returned to the service station which is not illustrated. In the following description, the operation in the meantime is referred to as a printing operation.

The operations of the liquid ejection heads 5 in the printing operation will be described below in detail.

In the side shoot type as in this embodiment, in the circulation type liquid ejection head 5, ink is made to flow in the circulation channel 23 by first operating the supply pump 24, the recovery pump 25, and the suction pump 26.

That is, first, ink is supplied from the main tank 4 to the supply sub tank 8 via the first liquid supply tube 21a. Thereafter, ink is supplied from the supply sub tank 8 to the ejection channels 62 of the head tip 50 via the second liquid supply tube 21b and the supply channel 95. The supply of ink from the supply sub tank 8 to the head tip 50 is performed using a head difference between the supply sub tank 8 and the discharge sub tank 9.

Thereafter, ink is discharged from the ejection channel 62 of the head tip 50 to the discharge sub tank 9 via the discharge channel 96 and the second liquid discharge tube 22b. The discharge of ink from the head tip 50 to the discharge sub tank 9 is performed by using the head difference between the supply sub tank 8 and the discharge sub tank 9 by the suction pump 26.

The ink discharged to the discharge sub tank 9 is suctioned by the recovery pump 25 and is returned to the main tank 4 when the amount ink is larger than a predetermined amount. Ink is supplied to the first liquid supply tube 21a by the supply pump 24 again. By repeating this operation, ink circulates between the liquid ejection head 5 and the main tank 4.

When round-trip movement is started by the carriage 33 (see FIG. 1), a control unit which is not illustrated applies driving voltage to the driving electrodes which is not illustrated. Then, the volume in the ejection channel 62 varies to pressurize ink. As a result, ink of a droplet shape (an ink droplet) is ejected to the outside through the nozzle hole 71 and the ink droplet is impacted on the printing medium P. The ink droplets impacted on the printing medium P are accumulated to print characters or figures.

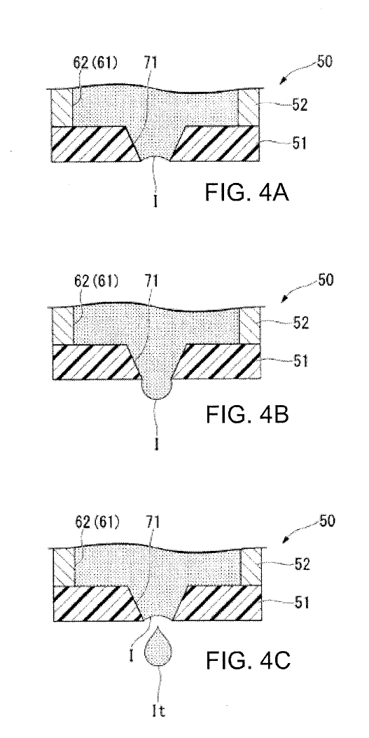

Behavior of an ink droplet It which is ejected from the nozzle hole 71 will be described below in detail with reference to FIGS. 4A, 4B, and 4C.

FIGS. 4A, 4B, and 4C are diagrams illustrating ink which is ejected from the nozzle hole 71, where behavior of the ink is illustrated.

First, as illustrated in FIG. 4A, an appropriate meniscus (a concave meniscus) is held not to eject ink I from the nozzle hole 71 in a normal state (when ink I is not ejected).

When ink I in the ejection channel 62 is pressurized from this state as illustrated in FIG. 4B, first, ink I protrudes downward in the Z direction from the nozzle hole 71. At this time, the ink I holds an appropriate meniscus. That is, the ink I forms a protruding meniscus within a hole diameter of the nozzle hole 71 without causing the ink I to wetly spread to the surrounding of the nozzle hole 71 of the nozzle plate 51.

The ink I vigorously pushed out of the ejection channel 62 is completely separated from the nozzle plate 51 to form an ink droplet It as illustrated in FIG. 4C. The ink droplet It drops down in the Z direction.

Here, a driving voltage of an appropriate frequency is applied to the actuator plate 52 such that the ink I is ejected as the ink droplet It with an appropriate meniscus held while transitioning from the state of ink I illustrated in FIG. 4B to the state of the ink droplet It illustrated in FIG. 4C.

When the printing operation is performed or the ink ejection head is initially filled with ink, ink may be attached to the surrounding of the nozzle hole 71 of the nozzle plate 51. Hereinafter, a maintenance operation (hereinafter simply referred to as maintenance) of removing the attached ink will be described in detail.

(Maintenance Method)

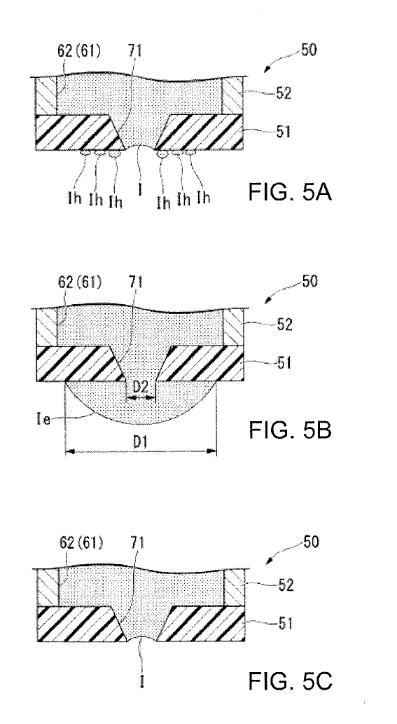

FIGS. 5A to 5C are diagrams illustrating a maintenance method, where behavior of ink is illustrated.

As illustrated in FIG. 5A, when the printing operation is performed to a certain extent, ink Ih is attached to the surrounding of the nozzle hole 71 of the nozzle plate 51 (hereinafter, the attached ink is referred to as attached ink Ih).

Therefore, the maintenance is performed at a predetermined timing in the printing operation. Here, the predetermined timing is a timing at which an ink droplet It is not ejected from the nozzle hole 71. More preferably, the maintenance is performed at a position at which the round-trip movement of the carriage 33 is switched, that is, when the carriage 33 (the liquid ejection head 5) is located at a position offset from a printing area of a printing medium P.

In the maintenance, first, the suction pump 26 disposed in the second liquid discharge tube 22b is stopped to intercept the channel of the second liquid discharge tube 22b. At this time, the channel of the second liquid discharge tube 22b is intercepted, but ink is continuously supplied to the liquid ejection head 5 due to the head difference between the supply sub tank 8 and the discharge sub tank 9.

Then, ink in the ejection channel 62 is continuously pressurized and the meniscus of ink I in the nozzle hole 71 is broken as illustrated in FIG. 5B. A lump of trapped liquid Ie is formed on the nozzle plate 51 (a trapped liquid forming step).

Here, the lump of trapped liquid Ie refers to that ink I wetly spreads to the surrounding of the nozzle hole 71 of the nozzle plate 51 by breaking the meniscus. More specifically, the diameter D1 of a part of the lump of trapped liquid Ie in contact with the nozzle plate 51 is larger than the diameter D2 of the nozzle hole 71. By forming the lump of trapped liquid Ie, the attached ink Ih is adsorbed by the lump of trapped liquid Ie to form a lump of trapped liquid Ie.

Subsequently, when the suction pump 26 is driven again, ink I stopped in the second liquid discharge tube 22b is discharged to the discharge sub tank 9 again.

Accordingly, as illustrated in FIG. 5C, the lump of trapped liquid Ie is suctioned into the ejection channel 62 (the channel 61) (a suction step). At this time, since the attached ink Ih forming the lump of trapped liquid Ie is also suctioned, the attached ink Ih is removed. An appropriate meniscus of ink I is formed in the nozzle hole 71 again. Thereafter, the printing operation is continuously performed.

In this way, in the first embodiment, a lump of trapped liquid Ie is formed in the nozzle plate 51 to cover the nozzle hole 71 and the surrounding of the nozzle hole 71 in performing the maintenance. Accordingly, the attached ink Ih of the nozzle plate 51 can be adsorbed using the lump of trapped liquid Ie. Thereafter, by suctioning the lump of trapped liquid Ie, the attached ink Ih along with the lump of trapped liquid Ie can be recovered to the ejection channel 62 (the channel 61).

Since the maintenance can be performed with this simple operation, it is possible to prevent complication of maintenance control and to satisfactorily prevent ink ejection failure of the liquid ejection printing device 1. Since it is not necessary to form a recovery hole other than the nozzle hole 71 unlike in the related art, it is possible to perform maintenance using an inexpensive method.

It is not necessary to once return the liquid ejection head 5 (the carriage 33) to a service station in performing the maintenance, and the maintenance can be performed when the printing operation on a printing medium P is performed and ink I is not ejected. Accordingly, it is possible to shorten a maintenance time.

In an acceleration/deceleration area of the carriage 33 (the liquid ejection head 5) in which ejection of ink droplets It is not performed, deflection of ink ejection or ejection failure of an ink droplet It due to the ink Ih attached to the nozzle plate 51 can be recovered for every round-trip movement.

In performing the maintenance, a lump of trapped liquid Ie is formed by pressurizing ink I in the ejection channel 62 to break the meniscus formed in the nozzle hole 71. Since the lump of trapped liquid Ie is formed in the nozzle plate 51 using this simple method, it is possible to further facilitate the maintenance control.

In order to pressurize ink I in the ejection channel 62 in performing the maintenance, a head difference is formed between the supply sub tank 8 and the discharge sub tank 9. Thus, the pressure of ink I in the second liquid supply tube 21b is set to be normally larger than the pressure of ink I in the second liquid discharge tube 22b. In addition, the second liquid discharge tube 22b is provided with the suction pump 26. By stopping the suction pump 26, the pressure of ink I in the ejection channel 62 is increased to an extent in which a lump of trapped liquid Ie can be formed.

It is possible to satisfactorily increase the pressure of ink I in the ejection channel 62 with this simple structure using simple control and to satisfactorily form a lump of trapped liquid Ie.

In the first embodiment, a case in which the suction pump 26 is disposed to intercept or open the second liquid discharge tube 22b has been described above. However, any configuration may be employed as long as it can intercept or open the second liquid discharge tube 22b on the basis of a control signal from a controller which is not illustrated. For example, an electromagnetic valve (not illustrated) may be disposed upstream from the suction pump 26 of the second liquid discharge tube 22b. By disposing the electromagnetic valve, the second liquid discharge tube 22b can be intercepted while the suction pump 26 is driven. Various valves can be applied instead of the electromagnetic valve.

In the first embodiment, the following two operations have been performed to form a lump of trapped liquid Ie in the nozzle plate 51:

(1) ink I in the ejection channel 62 (the channel 61) is pressurized; and

(2) a meniscus formed in the nozzle hole 71 is broken.

In order to perform the operation of (1), a case in which the supply sub tank 8 is disposed such that the liquid level of the supply sub tank 8 is higher than the liquid level of the discharge sub tank 9 and the head difference between the supply sub tank 8 and the discharge sub tank 9 is used has been described above.

However, the present invention is not limited thereto, but various methods for realizing the operation of (1) can be used.

### Modified Example of First Embodiment

For example, ink I in the ejection channel 62 (the channel 61) may be pressurized using the head difference which is generated due to an inertial force applied to the ink I when the round-trip movement of the carriage 33 is switched.

When this method is employed, a difference between the liquid level of the supply sub tank 8 and the liquid level of the discharge sub tank 9 which are set in advance can be set to be smaller than the head difference in the first embodiment. Since the inertial force at the time of switching the round-trip movement of the carriage 33 is used, the maintenance can be performed at a position at which the carriage 33 (the liquid ejection head 5) departs from the printing area of a printing medium P under the printing operation.

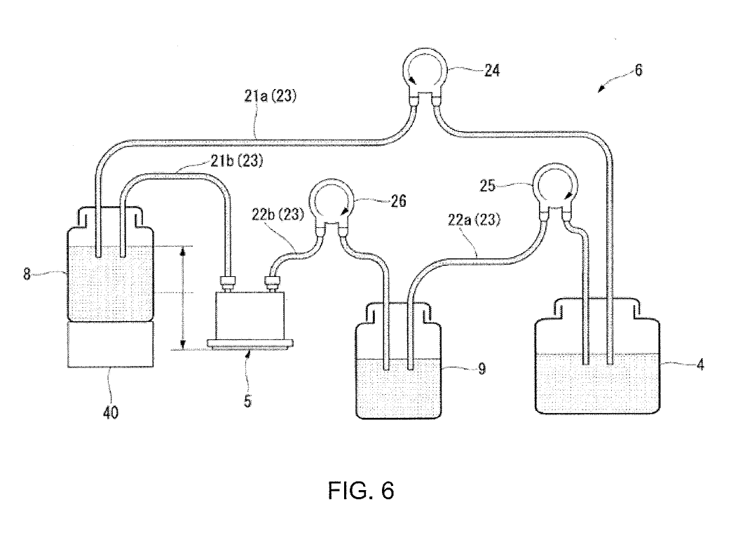

FIG. 6 is a diagram schematically illustrating configurations of a liquid ejection head 5, sub tanks 8 and 9, and a liquid circulating unit 6 according to a modified example of the first embodiment of the present invention and corresponds to FIG. 2 in the first embodiment.

As illustrated in the drawing, for example, a lifting unit 40 that can lift the supply sub tank 8 may be disposed in the carriage 33.

A specific operation when the lifting unit 40 is used will be described below. By driving the lifting unit 40, the height of the supply sub tank 8 is changed. The head difference between the supply sub tank 8 and the discharge sub tank 9 is changed accordingly. The pressurizing force applied to ink I in the ejection channel 62 is changed with the change in the head difference. That is, the larger the height of the supply sub tank 8 becomes, the larger the pressurizing force applied to ink I in the ejection channel 62 becomes.

Therefore, according to the modified example of the first embodiment, it is possible to achieve the same advantages as described in the first embodiment.

In performing the maintenance, it is possible to form a lump of trapped liquid Ie in the nozzle plate 51 without stopping the suction pump 26 by raising the position of the supply sub tank 8 using the lifting unit 40. Accordingly, it is not necessary to repeatedly stop and drive the suction pump 26 and it is possible to achieve extension of a lifespan of the suction pump 26.

### Second Embodiment

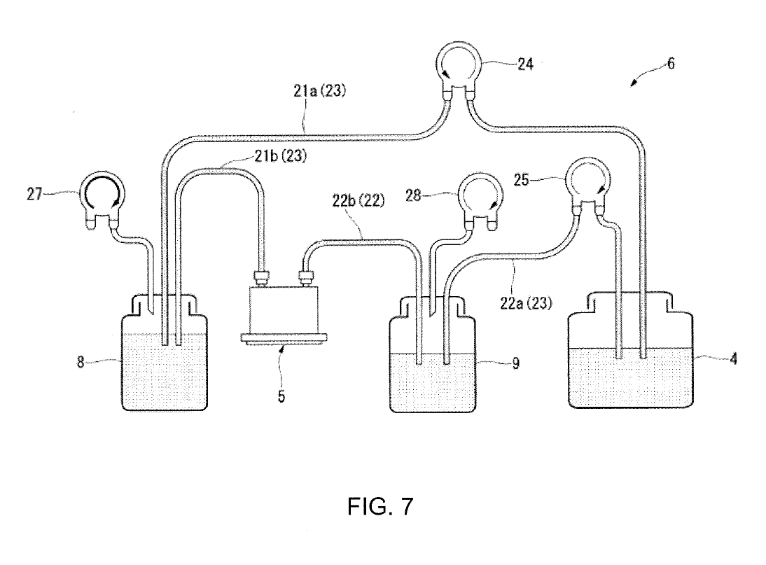

A second embodiment will be described below with reference to FIG. 7.

FIG. 7 is a diagram schematically illustrating configurations of a liquid ejection head 5, sub tanks 8 and 9, and a liquid circulating unit 6 according to a second embodiment and corresponds to FIG. 2 in the first embodiment. The same elements as in the first embodiment will be referenced by the same reference signs and description thereof will not be repeated (the same is true of the following embodiments).

The second embodiment and embodiments subsequent to the second embodiment are modified examples for realizing the operation of (1) in the first embodiment.

As illustrated in FIG. 7, in the second embodiment, the suction pump 26 of the first embodiment is not disposed in the second liquid discharge tube 22b. Instead, a pressurization air pump 27 is disposed in the supply sub tank 8 and a depressurization air pump 28 is disposed in the discharge sub tank 9. In the second embodiment, the supply sub tank 8 and the discharge sub tank 9 are disposed to have the same liquid level. The second embodiment is different from the first embodiment in this point.

On the basis of this configuration, in the printing operation of the liquid ejection printing device 1, the supply sub tank 8 is depressurized by driving the pressurization air pump 27 and the discharge sub tank 9 is depressurized by driving the depressurization air pump 28. Accordingly, ink I circulates between the liquid ejection head 5 and the main tank 4.

On the other hand, in performing the maintenance, the pressurization by the pressurization air pump 27 is increased. Then, a pressurizing force to ink I in the ejection channel 62 increases to form a lump of trapped liquid Ie in the nozzle plate 51.

Therefore, according to the second embodiment, the same advantages as described in the first embodiment can be achieved.

In the second embodiment, a case in which the pressurizing force to ink I in the ejection channel 62 is increased by increasing the pressurization by the pressurization air pump 27 has been described above. However, the embodiment is not limited thereto, but the pressurizing force to ink I in the ejection channel 62 may be increased by stopping the depressurization air pump 28, decreasing a degree of depressurization, or opening the depressurization air pump 28 to the air while driving the pressurization air pump 27 as in a normal state.

The second liquid discharge tube 22b may be provided with an electromagnetic valve which is not illustrated, and the second liquid discharge tube 22b may be intercepted by the electromagnetic valve. Accordingly, it is possible to increase a pressurizing force to ink I in the ejection channel 62.

### Third Embodiment

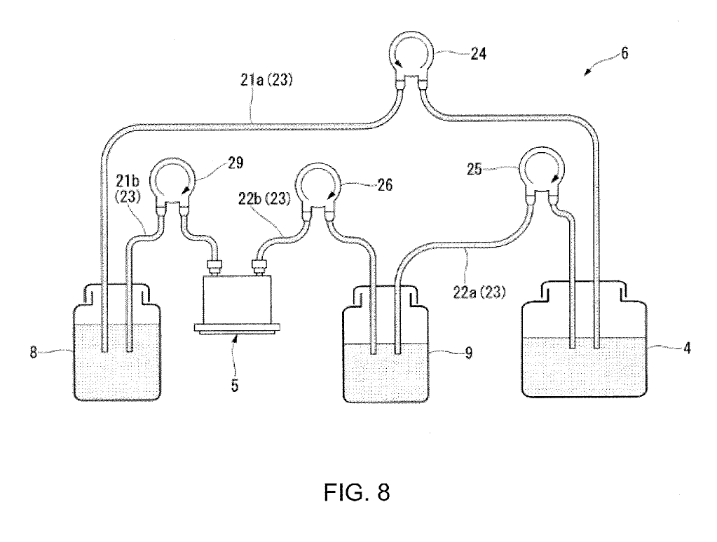

A third embodiment will be described below with reference to FIG. 8.

FIG. 8 is a diagram schematically illustrating configurations of a liquid ejection head 5, sub tanks 8 and 9, and a liquid circulating unit 6 according to a third embodiment and corresponds to FIG. 2 in the first embodiment.

As illustrated in the drawing, in the third embodiment, the second liquid supply tube 21b is provided with a feed pump 29. The third embodiment is different from the first embodiment in this point.

The feed pump 29 has a sealed structure so as not to open the second liquid supply tube 21b to the air when it is stopped. For example, a so-called tube pump is used as the feed pump 29.

On the basis of this configuration, ink I can be circulated in the liquid ejection head 5 by driving the feed pump 29 and the suction pump 26 regardless of the liquid level of the main tank 4 or the sub tanks 8 and 9. In this case, the feed pump 29 and the suction pump 26 are driven in synchronization with each other at the same driving speed.

In the third embodiment, the following two methods can be used to pressurize ink I in the ejection channel 62 (the channel 61):

(I) the suction pump 26 is stopped and only the feed pump 29 is driven; and

(II) the suction pump 26 is driven and the driving speed of the feed pump 29 is set to be higher than the driving speed of the suction pump 26.

By employing these methods, it is possible to pressurize ink I in the ejection channel 62 (the channel 61).

Both or one of the suction pump 26 and the feed pump 29 may be configured to open the corresponding second liquid supply tube 21b or the corresponding second liquid discharge tube 22b to the air when they or it is stopped. Here, when the feed pump 29 is configured in an air opened structure and the suction pump 26 is configured in a sealed structure, it is necessary to provide a head difference between the supply sub tank 8 and the discharge sub tank 9.

An electromagnetic valve (not illustrated) may be disposed upstream from the suction pump 26 in the second liquid discharge tube 22b. By disposing the electromagnetic valve to intercept the second liquid discharge tube 22b, it is possible to pressurize ink I in the ejection channel 62 (the channel 61) while driving the suction pump 26.

The present invention is not limited to the above-mentioned embodiments, but includes various modifications of the above-mentioned embodiments without departing from the gist of the present invention.

For example, in the above-mentioned embodiments, a so-called ink jet printer has been described as an example of the liquid ejection printing device 1. However, the above-mentioned embodiments are not limited thereto, but may be applied to, for example, a facsimile or an on-demand printer. For example, the above-mentioned embodiments can be applied to a large-size printer not including a pair of conveyance mechanisms 2 and 3 that conveys a printing medium P.

The above-mentioned embodiments can be employed in a so-called stationary printer not including the scanning unit 7 that causes the liquid ejection head 5 to scan. In case of the stationary printer, the method of pressurizing ink I in the ejection channel 62 (the channel 61) using a head difference due to an inertial force applied to the ink I when the round-trip movement of the carriage 33 is switched cannot be employed unlike the modified example of the first embodiment.

In the above-mentioned embodiments, the liquid ejection printing device 1 for multiple colors on which multiple liquid ejection heads 5 are mounted has been described. However, the above-mentioned embodiments are not limited thereto, but may be applied to, for example, a liquid ejection printing device for a single color on which one liquid ejection head 5 is mounted.

What is claimed is:

1. A maintenance method of a liquid ejection printing device including:
a liquid tank that stores liquid;
a liquid ejection head that ejects the liquid to a printing medium; and
a liquid circulating unit that circulates the liquid between the liquid tank and the liquid ejection head,
the liquid ejection head including:
a nozzle plate in which a nozzle hole through which the liquid is ejected is formed; and
a plurality of channels that communicates with the nozzle hole and is filled with the liquid,
the liquid circulating unit including:
a liquid supply tube that supplies the liquid from the liquid tank to the liquid ejection head; and
a liquid discharge tube that discharges the liquid from the liquid ejection head,
the maintenance method comprising steps of:
forming a lump of trapped liquid on the nozzle plate so as to cover the nozzle hole and a surrounding of the nozzle hole with the liquid while a printing operation onto the printing medium is performed and the liquid is not ejected; and
suctioning the lump of trapped liquid into the corresponding channel after the step of forming the lump of trapped liquid.

2. The maintenance method of a liquid ejection printing device according to claim I, wherein, in the step of forming the lump of trapped liquid, the lump of trapped liquid is formed by pressurizing the liquid in the channel so as to break a meniscus formed in the nozzle hole.

3. The maintenance method of a liquid ejection printing device according to claim 2, wherein, in the step of forming the lump of trapped liquid, the liquid in the channel is pressurized by pressurizing the liquid in the liquid supply tube.

4. The maintenance method of a liquid ejection printing device according to claim 3, wherein a pressurization pump is disposed in the liquid supply tube, and the liquid in the liquid supply tube is pressurized by the pressurization pump.

5. The maintenance method of a liquid ejection printing device according to claim 3, wherein the liquid tank includes:
a supply sub tank that is connected to the liquid supply tube; and
a discharge sub tank that is connected to the liquid discharge tube, and
a position of the supply sub tank is set to be higher than a position of the discharge sub tank so that the liquid in the liquid supply tube is pressurized by a head difference between a liquid level of the liquid in the supply sub tank and a liquid level of the liquid in the channel.

6. The maintenance method of a liquid ejection printing device according to claim 5, wherein
an intercept portion that is capable of intercepting a channel of the liquid in the liquid discharge tube is disposed in the liquid discharge tube, and
the liquid in the liquid supply tube is pressurized by the head difference caused by intercepting the channel of the liquid discharge tube using the intercept portion.
